(19) United States
(12) Patent Application Publication
(10) Pub. No.: US 2009/0061773 A1
(43) Pub. Date: Mar. 5, 2009

(54) DEVICE ISOLATION AND DATA TRANSFER FOR WIRELESS MEMORY

(76) Inventors: Weng Wah LOH, Bristol (GB); Fraser John Dickin, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/200,274

(22) Filed: Aug. 28, 2008

Related U.S. Application Data
(60) Provisional application No. 60/968,454, filed on Aug. 28, 2007.

(51) Int. Cl. H04B 7/00

(52) U.S. Cl. 455/41.2

(57) ABSTRACT

A method of enabling communication is described. The method comprises transmitting a channel identifier and an a socket identifier to an initiator responsive to performing a reset of the channel identifier and the socket identifier on one or more target devices. The method also comprises communicating with an identified target device of the one or more target devices based on the transmitted channel identifier and the transmitted socket identifier of the identified target device responsive to receipt of the channel identifier and the socket identifier. The method also comprises enumerating two or more identified target devices of the one or more target devices based on a collision detection of transmitted channel identifiers and socket identifiers of the two or more identified target devices.

### CROSS-REFERENCE TO RELATED APPLICATION

This application claims the benefit of Provisional Patent Application No. 60/968,454, filed Aug. 28, 2007, and titled, “DEVICE ISOLATION AND DATA TRANSFER FOR WIRELESS MEMORY”, the entirety of which is hereby incorporated by reference herein.

### BACKGROUND

Prior approaches exist for setting up and managing a communication link between two or more wireless devices. Some examples include BLUETOOTH, WIFI, etc.

Communication protocols according to prior approaches are designed for large computing systems such as personal computers or embedded computing platforms where computation power, power requirements, and memory are plentiful.

### DESCRIPTION OF THE DRAWINGS

One or more embodiments are illustrated by way of example, and not by limitation, in the figures of the accompanying drawings, wherein elements having the same reference numeral designations represent like elements throughout and wherein:

FIG. 1 is a high-level diagram of a transaction according to an embodiment;

FIG. 2 is a high-level diagram of a transaction according to another embodiment;

FIG. 3 is a diagram of a standard frame format according to an embodiment;

FIG. 4 is a diagram of a start of frame sequence according to an embodiment;

FIG. 5 is a diagram of a header frame according to an embodiment;

FIG. 6 is a diagram of a target to initiator standard frame format according to an embodiment;

FIG. 7 is a diagram of communication channels according to an embodiment;

FIG. 8 is a diagram of an initiator to target broadcast ResetID frame according to an embodiment;

FIG. 9 is a diagram of an initiator to target ResetID frame according to an embodiment;

FIG. 10 is a diagram of a ResetID response frame format according to an embodiment;

FIG. 11 is a diagram of an initiator to target broadcast ReportID frame format according to an embodiment;

FIG. 12 is a diagram of a ReportID response frame format according to an embodiment;

FIG. 13 is a diagram of a target flowchart according to an embodiment;

FIG. 14 is a diagram of an initiator flowchart according to an embodiment;

FIG. 15 is a diagram of an initiator to target Read frame format according to an embodiment;

FIG. 16 is a diagram of a GeneralRead response frame format according to an embodiment;

FIG. 17 is a diagram of an initiator to target Write frame format according to an embodiment;

FIG. 18 is a diagram of an initiator to target WriteSync frame format according to an embodiment;

FIG. 19 is a diagram of an initiator to target PageErase frame format according to an embodiment;

FIG. 20 is a diagram of an initiator to target MassErase frame format according to an embodiment;

FIG. 21 is a diagram of an initiator to target broadcast Authenticate frame format according to an embodiment;

FIG. 22 is a diagram of a GeneralRead response frame format according to an embodiment;

FIG. 23 is a diagram of an initiator to target broadcast ReportID frame format according to an embodiment;

FIG. 24 is a diagram of a ReportID response frame format according to an embodiment;

FIG. 25 is a diagram of an initiator to target ResetID frame format according to an embodiment;

FIG. 26 is a diagram of a ResetID response frame format according to an embodiment;

FIG. 27 is a diagram of an ACK response frame format according to an embodiment;

FIG. 28 is a diagram of a NACK response frame format according to an embodiment;

FIG. 29 is a diagram of a memory map according to an embodiment;

FIG. 30 is a diagram of an LFSR circuit according to an embodiment;

FIG. 31 is a diagram of an example scrambling circuit according to an embodiment;

FIG. 32 is a diagram of a challenge-response according to an embodiment; and

FIG. 33 is a diagram of a string message according to an embodiment.

### DETAILED DESCRIPTION

A memory tag is a memory device based on a low-power integrated circuit design, e.g., complimentary metal oxide semiconductor (CMOS), and is about the size of a grain of rice or smaller (2 millimeter (mm) to 4 mm square), with a built-in antenna. In at least some embodiments, the memory tags may be embedded in a sheet of paper or stuck to any surface, and may be available in a booklet as self-adhesive dots. An example memory tag is a memory spot available from HEWLETT-PACKARD CO. of Palo Alto, Calif.

The memory tag or memory tag chip has a 10 megabits-per-second data transfer rate—10 times faster than BLUETOOTH wireless technology and comparable to [[Wi-Fi]]WI-FI speeds—effectively giving users instant retrieval of information, e.g., in audio, video, photo and/or document form. With a storage capacity ranging from 256 kilobits to 4 megabits in working prototypes, the memory tag is able to store, for example, a very short video clip, several images or dozens of pages of text.

Information stored on the memory tag is accessed by a read-write device, e.g., as incorporated into a cell phone, PDA, camera, printer or other device. To access information, the read-write device is positioned adjacent, i.e., closely over, the chip, which is then powered so that the stored data is transferred to the display of the phone, camera or PDA or printed out by the printer. Users can also add information to the chip using the various devices.

The chip incorporates a built-in antenna and is self-contained, with no need for a battery or external electronics. [[It]][The chip receives power through inductive coupling from a special read-write device, which [[can]] then extracts content from the memory on the chip. Inductive coupling is the transfer of energy from one circuit component to another through a shared electromagnetic field. A change in current flow through one device induces current flow in the other device.

The memory tag communication protocol begins by emulating available memory tag targets within the interrogator's energy field (also called field-of-view). In at least some embodiments, the protocol begins by emulating all available memory-tag targets within the interrogator's energy field. This is achieved using the following simple rules which are an aspect of [[this]]embodiments of the present invention:

Target's operating rules:—
All target's channel identifier (ChannelID) and socket identifier (SocketID) are reset to 00 upon restoration of power—cold boot. Target responds to commands issued on the channel in which it is operating in and with matching socket ID [[OR]]or to commands issued on a broadcast channel. In at least some embodiments, target responds only to commands issued on the channel in which it is operating in which and with matching socket ID or to commands issued on a broadcast channel.

Interrogator's operating rules:—

The device detection scheme is the channel selection method. The number of channels is given by an integer value N between 1 and 13 inclusive, which is determined by the initiator. In alternate embodiments, greater or fewer than 13 may be used. The initiator sends a ‘ResetID’ command either on the broadcast channel (0xFH) or on the reset channel (0x0H). If the ‘ResetID’ command is issued on the broadcast channel, all targets on all channels select a random ChannelID between 1 and N and a SocketID between 0 and 4096. If the ‘ResetID’ is issued on a particular channel (y), only targets operating on channel (y) select a random ChannelID between 1 and N and a SocketID between 0 through 4096. Targets operating on all other channels (not y) retain their ChannelID and SocketID.
If a reply is received from the target in response to a ‘ResetID’ command issued on the broadcast channel and is decoded with no CRC errors, only one target exists in the field of view. The emulation process is completed.
Standard communication between memory tag and initiator commences using the returned ChannelID and SocketID.
If a reply is received from the target in response to a ‘ResetID’ command issued on the broadcast channel and is decoded with CRC errors, a collision is deemed to have occurred. The initiator proceeds with the next phase to enumerate and isolate the targets.
The initiator issues a ‘ReportID’ frame on the channels it wishes to enumerate. The ‘ReportID’ frame may not have to be issued on any particular channel sequence. Only targets with ChannelID matching the CHAN field of the ‘ReportID’ frame process the frame.
The target processes the ‘ReportID’ frame if it is issued on a channel matching their own ChannelID. The target replies with the ‘ReportID’ response frame after the completion of the ReportID frame.
If a reply is received from the target in response to a ‘ReportID’ frame issued on a particular channel (x) and decoded with no CRC error, only one target is deemed to exist on that channel (x). The initiator may select to ‘park’ the said target to the PARKED channel (0xE) freeing up that particular channel (x) for use in further enumeration. Conversely, the initiator may commence normal communication with the target. The initiator may reassign the target to another channel with or without a new SocketID by writing to the target's ID Register.
The initiator may repeat the multiple target detection and isolation sequence (this time on channels with collision) until all targets have been isolated before initiating normal communication with the targets. Conversely, the initiator may repeat the multiple targets detection and isolation sequence (this time on channels with collision) as each device is isolated on a collision free channel.

### Memory Tag Communication Protocol V2

### 1.0 Standard Transaction Between Initiator and Target(s)

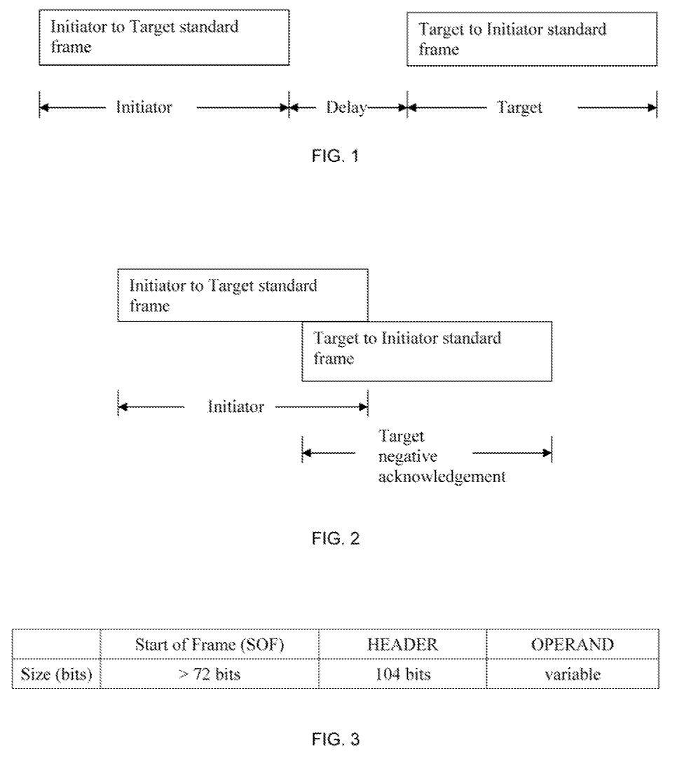

A successful standard transaction, as depicted in FIG. 1, consists of the transmission of Initiator to target standard frame and the reception of target to initiator standard frame.

### Successful Standard Transaction

In a successful transaction, the delay between the end of an Initiator to target standard frame and the beginning of the target to Initiator standard frame depends on the opcode issued by the initiator.

The target provides a response to processed initiator frames either in the form of an acknowledgement frame, a negative acknowledgement frame or a data frame. In at least some embodiments, the target provides a response to all processed initiator frames.

The target provides a negative acknowledgement frame if the received frame is corrupted and cannot be processed further. This may occur even before the initiator frame is completely received, as depicted in FIG. 2.

### Unsuccessful Transaction

### 2.0 Initiator to Target Encoding and Modulation

In at least some embodiments, the on-air encoding scheme is Manchester encoding for [[all]] initiator to target communication. This includes the preamble and framing sequences. The bit stream described hereforth is pre-Manchester encoded. In other embodiments, different encoding schemes may be used for communication. The presence of amplitude modulation of the carrier frequency signals the start of the passive communication.2.1 Initiator to Target standard frame format

The standard frame format, as depicted in FIG. 3, for initiator to target communication comprises a start of frame (SOF) and a header followed by an opcode-dependent, variable length operand frame.

### Initiator to Target Standard Frame Format

### 2.1.1 Start of Frame (SOF)

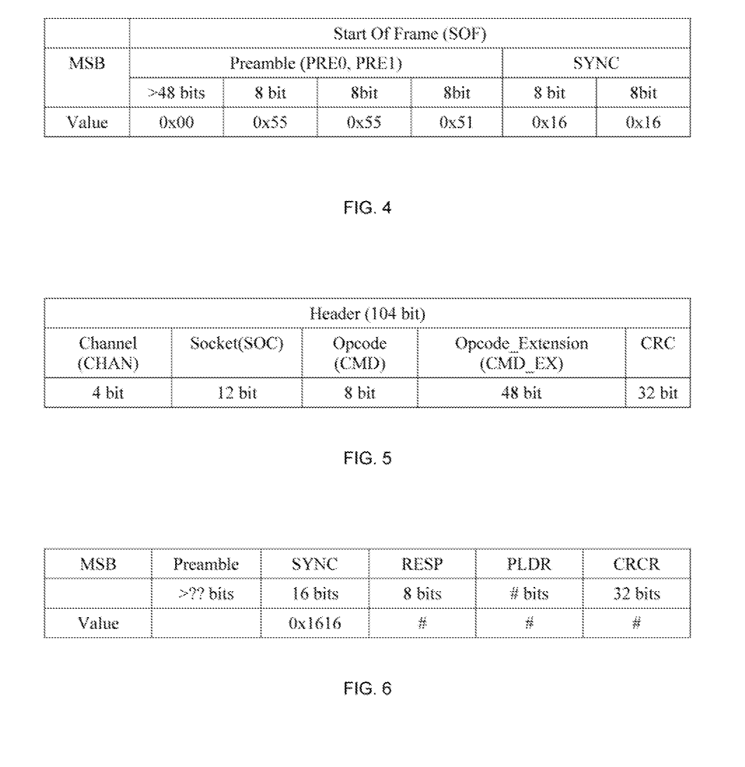

In at least some embodiments, communication starts with a preamble sequence of a minimum 48 bits which are all logical “zero” encoded followed by 24 bits which are logical ‘0101,0101,0101,0101,0101,0001’ (most significant bit (MSB) first). A pair of synchronization characters (SYNC) consisting of logical ‘0001011000010110’ (MSB first) [[shall]] immediately follow the preamble sequence. These sequences (preamble and SYNC pairs, e.g., as depicted in FIG. 4) make up the start of frame sequence and are used for all initiator to target communication.

FIG. 4 depicts a Start of Frame sequence for initiator to target communications according to an embodiment.

### 2.1.2 Header

### Header Framing Sequence

The header frame, e.g., as depicted in FIG. 5, begins with a 4 bit (CHAN) field that specifies to which channel [[this]]the frame is applied. The target processes frames with a CHAN value matching their own channel ID or frames with a CHAN value equal to 0xFF (broadcast channel). In at least some embodiments, the target only processes frames with a CHAN value matching their own channel ID or frames with a CHAN value equal to 0xFF.

The 12 bit SOC field specifies to which socket [[this]]the frame is applied immediately follows the CHAN field. The targets process frames with SOC value matching their own channel ID except for CMD values 0xFF (InitialiseID) and 0xFE (ReportID). In at least some embodiments, the targets only process frames with SOC value matching their own channel ID except for particular CMD values.

The CMD field specifies which operation the target is requested to perform. This 8 bit field consists of a number between 0x0 to 0x4 and 0xFE and 0xFF. All other values are reserved. In alternate embodiments, different field sizes and number specifications may be used.

In at least some embodiments, the opcode extension field (CMD_EX) is 48 bits. This field provides additional information on the opcode. The significance of each bit within this field is opcode-dependent.

The CRC field is a 32 bit CRC value of the CHAN, SOC, CMD, and CMD_EX fields.

### 2.1.3 Operand

The operand frame is of variable length and is opcode-dependent.

### 3.0 Target to Initiator Encoding and Modulation

In at least some embodiments, transmission between target to Initiator is encoded with a 7 bit data whitening word and uses backscattering phase modulation. The on-air encoding scheme applies to all fields except preamble and synchronization (SYNC). The bit stream described here forth is pre-encoded.

### 3.1 Target to Initiator Standard Frame Format

FIG. 6 depicts a target to Initiator standard frame format according to an embodiment (applicable to all target response frame)

Note: # denotes operational dependent values.
Preamble: This field consists at least 48 bit of alternating logical 0s and 1s. This field is not subjected to encoding.
SYNC: Synchronization. This is a pair of 8 bit synchronization symbols. The synchronization symbol is 0x16. This field is not subjected to encoding.
RESP: Target's response code, also referred to as a response field. This is a 8 bit field and is subjected to encoding. The responses are:
   0x02 Read
   0x05 AuthenticateEnquiry
   0x06 Acknowledgement
   0x15 NegativeAcknowledgement
   All other values are reserved
PLDR: Target's Payload, also referred to as a payload field (PLD). The size of this field is dependent on the requested operation and may be zero. This field is subjected to encoding.
CRCR: CRC of RESP and PLD field only; this field consists of 32 bits and is subjected to encoding. If PLD field is absent, the CRC is computed on the RESP field only.

### 4.0 Initialization and Device Detection

The target resets the ID register to 0x0000 upon detection of a “carrier loss, carrier present” sequence (power-on reset). The target ID register resides in memory location 0x100H. In at least some embodiments, [[The]]the initiator can force the target to perform a power-on reset at any time.

The target only processes frames with Channel ID and Socket ID matching their own with the following exceptions:

The target processes the ‘ResetID’ command, i.e., the reset identifier command, if [[it]]the command is issued on the broadcast channel (CHAN=0xF) or on a channel matching its channelID. The target shall not match the SocketID.

The target processes the ‘ReportID’ command if [[it]]the command is issued on a channel matching its channelID. The target shall not match the SocketID.

The device detection scheme is the channel selection method. The number of channels is given by an integer value N between 1 and 13 inclusive, which is determined by the initiator. The initiator may send a ‘ResetID’ command either on the broadcast channel (0xFH) or on the reset channel (0x0H). If the ‘ResetID’ command is issued on the broadcast channel, all targets on all channels select a random ChannelID between 1 and N and a SocketID between 0 and 4096. If the ‘ResetID’ is issued on a particular channel (y), only targets operating on channel (y) select a random ChannelID between 1 and N and a SocketID between 0 through 4096. Targets operating on all other channels (not y) retain their ChannelID and SocketID.

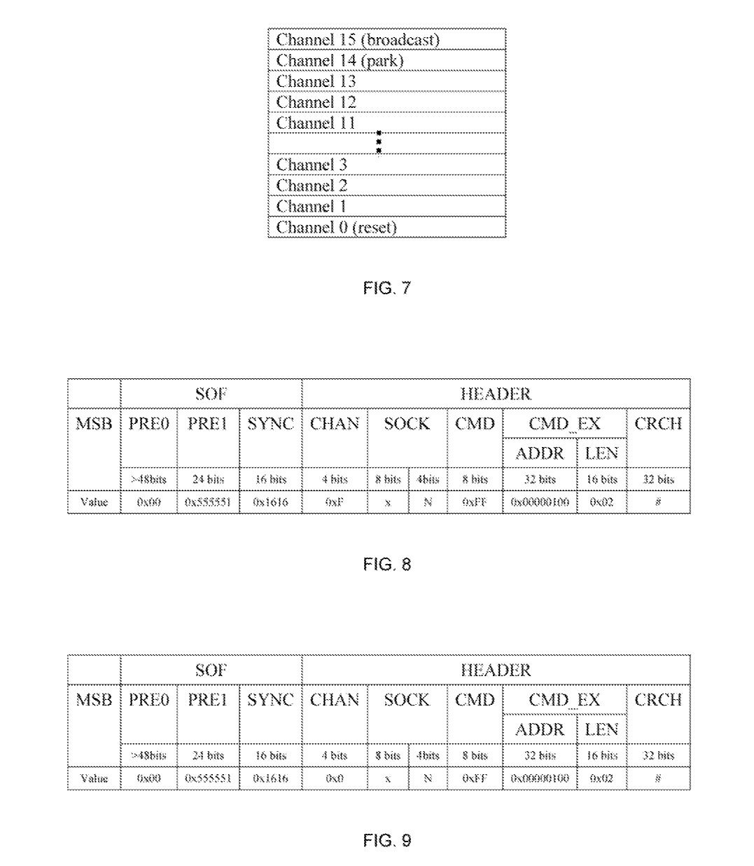

FIG. 7 depicts MSPV2 communication channels according to an embodiment.

Targets can only select channel 1 through 13 in response to ResetID command.

FIG. 8 depicts an Initiator to Target broadcast ‘ResetID’ frame according to an embodiment.

FIG. 9 depicts an Initiator to Target ‘ResetID’ frame for channel 0 according to an embodiment.

Note: x denotes any arbitrary values.

# denotes operational dependent values.

SOF field is described elsewhere.
CHAN: Channel number this frame is applied to. Valid values are 0 though 15. Channel 15 is the broadcast channel. All targets respond to a ‘ResetID’ frame if this is issued on a channel matching its ChannelID or on a broadcast channel.
SOCK: The initiator specifies the number of channels (N) available for this session. The value ranges from 1 through 13, all other values are invalid. The target ignores the 8 most significant bits
CMD: This value is 0xFF (ResetID opcode)
ADDR: This value is 0x00000100. (ID register location)
LEN: This value is 0x02.
CRCH: CRC of fields CHAN, SOCK, CMD, ADDR, LEN; this field is 32 bits

The targets respond to the ‘ResetID’ frame with their randomly generated ChannelID and SocketID using the standard target to initiator frame format after a maximum of a predetermined number of cycles.

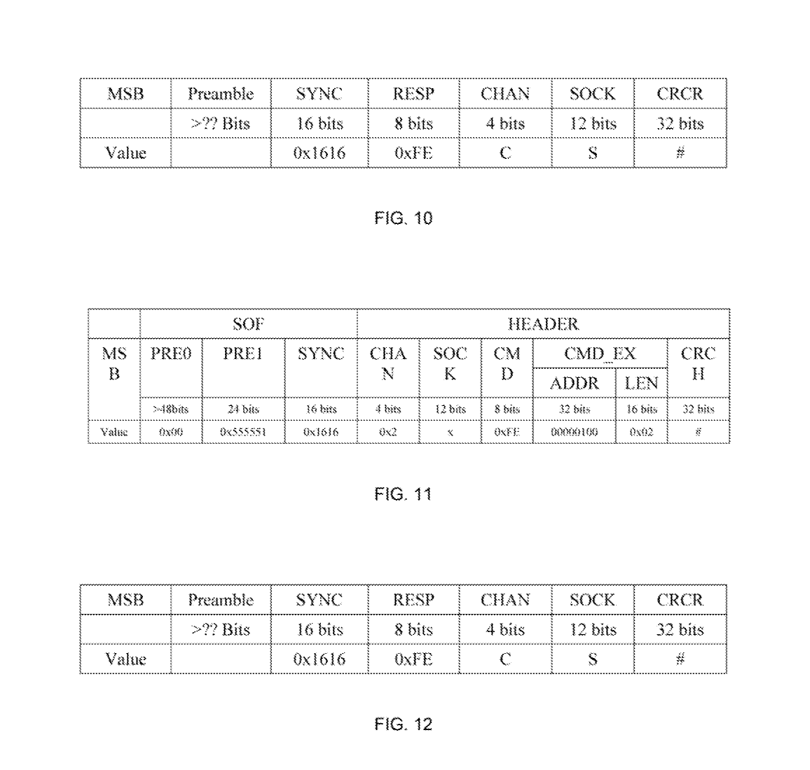

FIG. 10 depicts a ResetID response frame format according to an embodiment.

Note: # denotes operational dependent values.
RESP: This value is 0xFE (8 bits)
CHAN: This value is the target's ChannelID found in the ID register.
SOCK: This value is the target's SocketID found in the ID register.
CRCR: CRC of fields RESP, CHAN, and SOCK. This field is 32 bits.

### 4.1 Single Device Detection

If a reply is received from the target in response to a ‘ResetID’ command issued on the broadcast channel and is decoded with no CRC errors, only one target exists in the field of view. The emulation process is completed. Standard communication between memory tag and initiator commence using the returned ChannelID and SocketID.

### 4.2 Multiple Device Detection and Isolation

If a reply is received from the target in response to a ‘ResetID’ command issued on the broadcast channel and is decoded with CRC errors, a collision is deemed to have occurred. The initiator proceeds with the next phase to enumerate and isolate the targets.

The initiator issues a ‘ReportID’ frame on the channels to be enumerated. The ‘ReportID’ frame may not have to be issued on any particular channel sequence. Only targets with ChannelID matching the CHAN field of the ‘ReportID’ frame process the frame.

FIG. 11 depicts an Initiator to Target broadcast ‘ReportID’ frame according to an embodiment.

Note: x denotes any arbitrary values.

# denotes operational dependent values.

SOF field is described elsewhere.
CHAN: Channel number this frame is applied to. Valid values are 0 though 14. The target responds to ‘ReportID’ frame if this field matches it own ChannelID field.
SOCK: This field is 12 bit. The target ignores this field.
CMD: This value is 0xFE (Report ID opcode)
ADDR: This value is 0x00000100. (ID register location)
LEN: This value is 0x02
CRCH: CRC of fields CHAN, SOCK, CMD, ADDR, LEN; this field is 32 bits

The target processes the ‘ReportID’ frame if it is issued on a channel matching their own ChannelID. The target replies with the ‘ReportID’ response frame after the completion of the ReportID frame after a maximum of a predetermined number of cycles.

FIG. 12 depicts a ReportID response frame format according to an embodiment.

Note: # denotes operational dependent values.
RESP: This value is 0xFE
CHAN: This value is the target's ChannelID found in the ID register.
SOCK: This value is the target's SocketID found in the ID register.
CRCR: CRC of fields RESP, CHAN, and SOCK. This field is 32 bits.

If a reply is received from the target in response to a ‘ReportID’ frame issued on a particular channel (x) and decoded with no CRC error, only one target is deemed to exist on that channel (x). The initiator may select to park the said target to the PARKED channel (0xE) freeing up that particular channel (x) for use in further enumeration. Conversely, the initiator may commence normal communication with the target. The initiator may reassign the target to another channel with or without a new SocketID by writing to the target's ID Register.

The initiator may repeat the multiple target[[s]] detection and isolation sequence (this time on channels with collision) until all targets have been isolated before initiating normal communication with the targets. Conversely, the initiator may repeat the multiple targets detection and isolation sequence (this time on channels with collision) as each device is isolated on a collision free channel.

### 4.3 Recommended Initialization and Device Detection Scheme

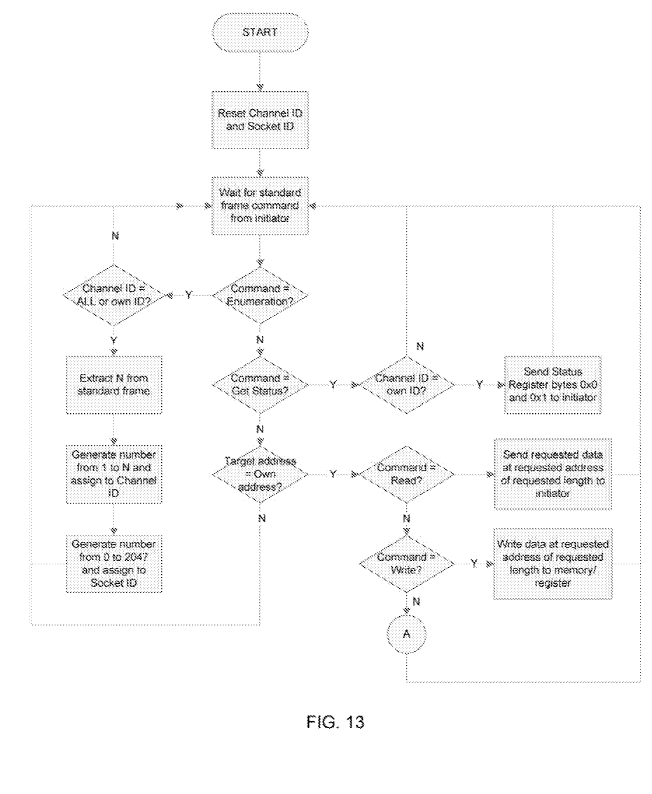

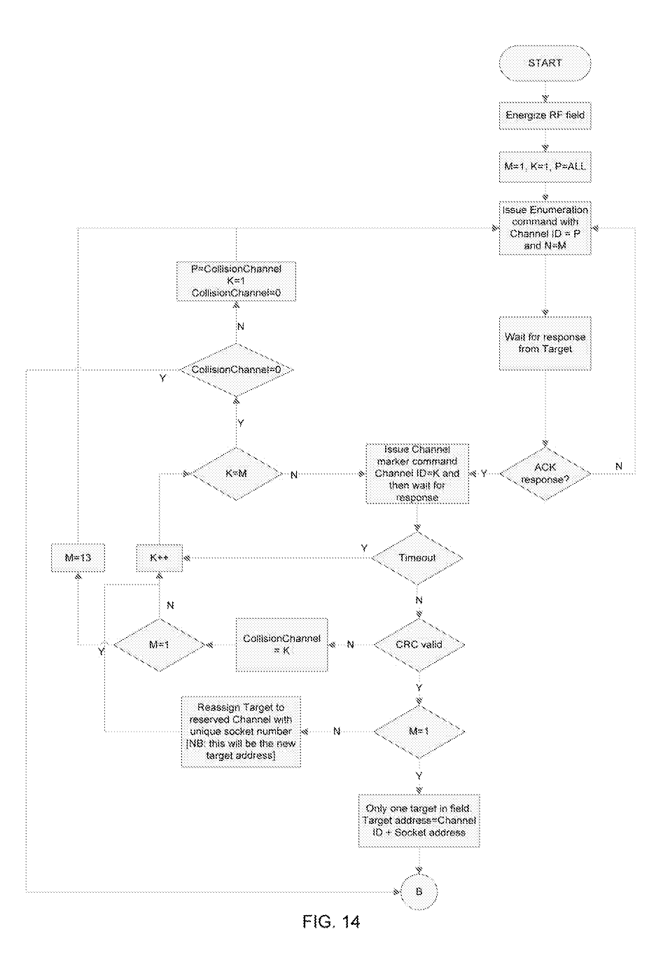

FIGS. 13 and 14 depict a target flowchart and an initiator flowchart, respectively, according to an embodiment.

### 5.0 Initiator to Target Frame and Target Response Frame

Preamble, SOF, CHAN, SOC and SYNC fields are described in their respective initiator to target standard frame format section and target to initiator standard frame format section.

5.1 Read from Target Frame (CMD=0x00)

Read one or more bytes from target starting from location ‘addr’.

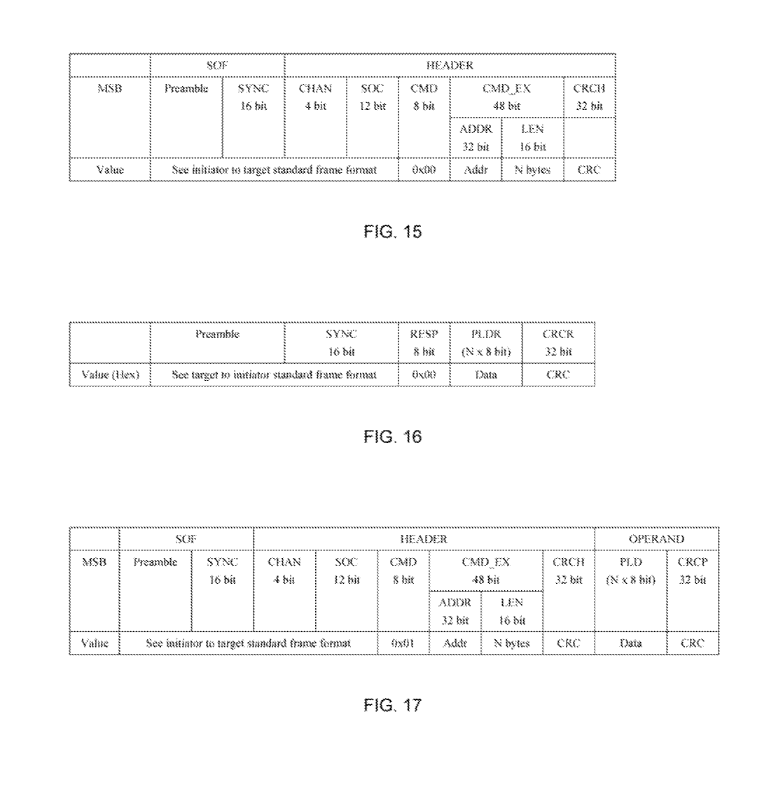

FIG. 15 depicts an initiator to target ‘Read’ frame format according to an embodiment.
CMD: This value is 0x00
ADDR: Target's start address from which data to be read from.
LEN: Length of data to read in bytes units (8 bits).
CRCH: CRC of CHAN, SOC, CMD, ADDR, LEN fields
   5.1.1 Read from Target Response Frame

FIG. 16 depicts a ‘GeneralRead’ response frame format according to an embodiment.
RESP: Response field. This value is 0x02
PLDR: Payload. This field contains the requested data of length N
CRC: CRC of RESP and PLD fields
   5.2 Write to Target Frame (CMD=0x01)

Write one or more bytes to target starting from location ‘addr’.

FIG. 17 depicts an initiator to target ‘Write’ frame format according to an embodiment.
CMD: This value is 0x01
ADDR: Target's start address from which data is to be written
LEN: Length (N) of data to write in bytes units (8 bits)
CRCH: CRC of CHAN, SOC, CMD, ADDR, LEN fields
PLD: Data to write of length (N) bytes
CRCP: CRC of PLD field

### 5.2.1 Write to Target Response Frame

Possible responses from target to a ‘Write’ frame include Acknowledgement (ACK) or Negative Acknowledgement (NACK) frame.

WriteSync to target frame (CMD=0x02)

Write one or more bytes to target starting from location ‘addr’, using SyncFlash algorithm.

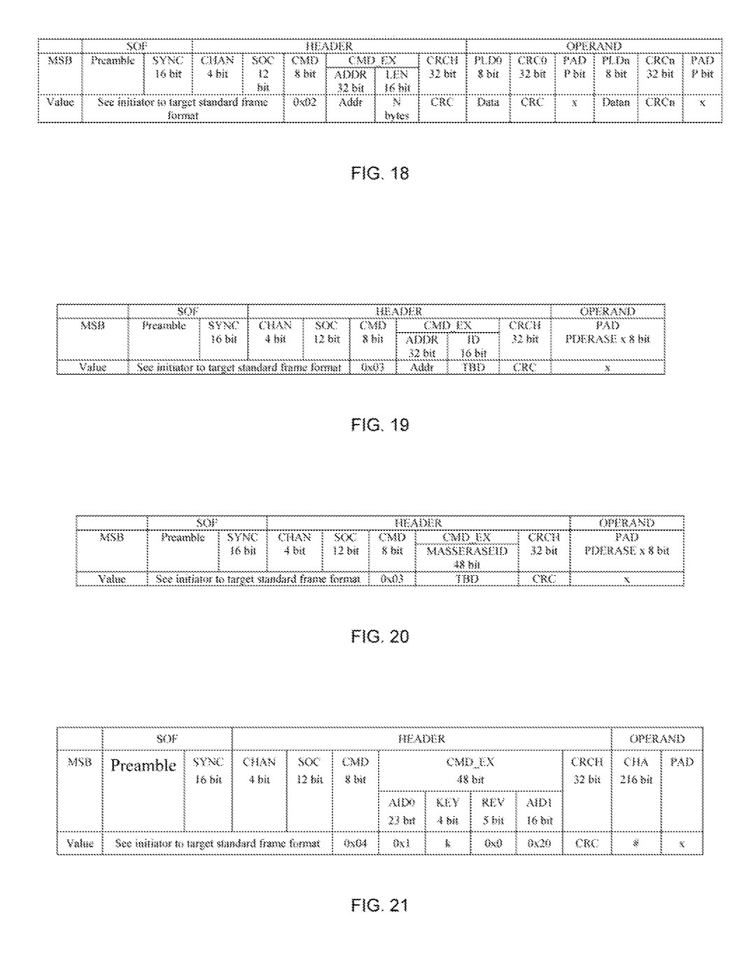

FIG. 18 depicts an initiator to target ‘WriteSync’ frame format according to an embodiment.

Note: x denotes any arbitrary values.
CMD: This value is 0x02
ADDR: Target's start address from which data is to be written
LEN: Length (N) of data to write in bytes units (8 bits)
CRCH: CRC of CHAN, SOC, CMD, ADDR, LEN fields
PLD0: 1^{st} data byte of payload
CRC0: CRC of 1^{st} data byte
PAD: Padding bytes. The size of this field is determined by the following formula:

Size=(STRT*PDSTRT+PDDATA+CROSS*PDRX+END*PDEND.)×8 bits
PDSTRT, PDDATA. PDRX, PDEND is obtained from the target's capabilities table (CT)
STRT: This is 1 for the 1^{st} byte and is 0 for subsequent bytes
CROSS: This is 1 if the address cross a row boundary and is 0 otherwise
END: This is 1 for the last byte and is 0 for subsequent bytes
CRCn: CRC of PLDn field

### 5.3.1 WriteSync to Target Response Frame

Possible responses from target to a ‘Write’ frame shall be Acknowledgement (ACK) or Negative Acknowledgement (NACK) frame.

5.4 PageErase Frame (CMD=0x03)

Initialize one page of target's memory. This operation only applies to target with Flash/EEPROM based memory. This operation will have no effect on “RAM type” memory, use ‘Write’ operation to overwrite contents for “RAM type” memory. The initialized value may be logical ‘1’ or logical ‘0’ and is dependent on the target memory technology.

FIG. 19 depicts an initiator to target ‘PageErase’ frame format according to an embodiment.

Note: x denotes any arbitrary values.
CMD: This value is 0x03
ADDR: Target's page to erase. The target eases the entire page specified in this value. For example, if the target page size is 256 bytes, erasing address 0x102H and 0x14FH means the same thing, that is the target erases page 1.
ID: TBD
CRCH: CRC of CHAN, SOC, CMD, ADDR, LEN fields
PAD: End of frame padding. The target ignores the contents of this field

### 5.4.1 PageErase Response Frame

Possible responses from target to a ‘Write’ frame include an Acknowledgement (ACK) or a Negative Acknowledgement (NACK) frame.

5.5 MassErase Frame (CMD=0x03)

Initialize entire target's memory. This operation only applies to target with Flash/EEPROM based memory. This operation has no effect on “RAM type” memory, use ‘Write’ operation to overwrite contents for “RAM type” memory. The initialized value may be logical ‘1’ or logical ‘0’ and is dependent on the target memory technology.

FIG. 20 depicts an initiator to target ‘MassErase’ frame format according to an embodiment.

Note: x denotes any arbitrary values.
CMD: This field is of the value 0x03H
MASSERASEID: TBD
CRCH: CRC of CHAN, SOC, CMD, CMD_EX fields
PAD: End of frame padding. This is PDERASE×8 bits. The target ignores the contents of this field

### 5.5.1 MassErase Response Frame

Possible responses from target to a ‘Write’ frame includes an Acknowledgement (ACK) or a Negative Acknowledgement (NACK) frame.

5.6 Authenticate Frame (CMD=0x04)

Authenticate target's (k) key, where (k) is 0 to 15. The target responds with a 180 bit SHA-1 message digest of the augmented challenge and secret key (k).

FIG. 21 depicts an initiator to target broadcast ‘Authenticate’ frame according to an embodiment.

Note: x denotes any arbitrary values.

# denotes operational dependent values.

SOF field is described elsewhere.
CMD: This value is 0x04
AID0: Authentication ID0. This field is 23 bit. The value is 0x1.
KEY: Authentication Key. This field indicates which key to authenticate and is 4 bits.
REV: This field is reserved and is 0xO.

AID1: Authentication ID1. This field is 16 bit. The value is 0x20.
CRCH: CRCH: CRC of CHAN, SOC, CMD, CMD_EX fields
CHA: Challenge. This field is 216 bit. The target uses this field as a challenge key
PAD: End of frame padding. This field is a predetermined number of bits. The target ignores the contents of this field.

### 5.6.1 Authenticate Response Frame

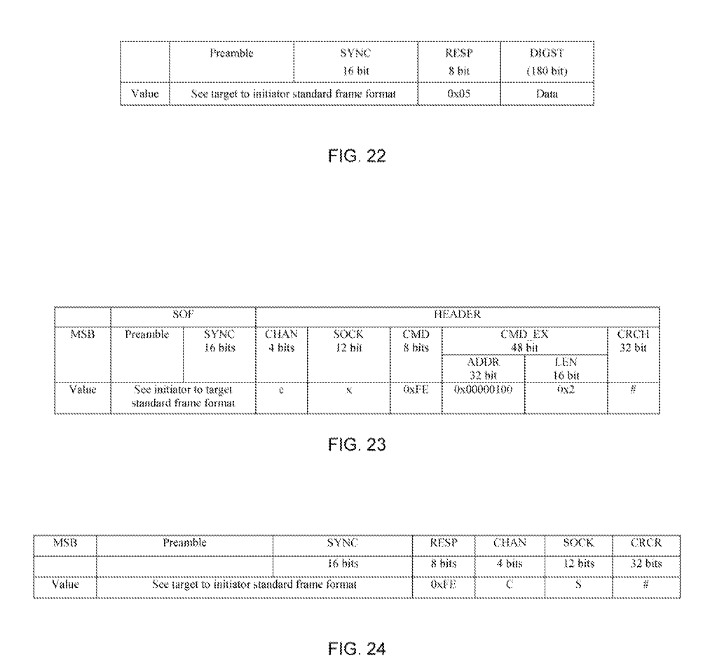

FIG. 22 depicts a ‘GeneralRead’ response frame format according to an embodiment.
RESP: Response field. This value is 0x05
DIGST: 180 bit SHA1 message digest of augmented challenge and secret key (k)

### 5.7 ReportID Frame

Retrieve target's ChannelID and SocketID value on channel (c). This frame is usually used for target enumeration and isolation.

FIG. 23 depicts an initiator to target broadcast ‘ReportID’ frame according to an embodiment.

Note: x denotes any arbitrary values.

# denotes operational dependent values.

SOF field is described elsewhere.
CHAN: Channel number this frame is applied to. Valid values are 0 though 14. The target responds to ‘ReportID’ frame if this field matches its own ChannelID field.
SOCK: This field is 12 bit. The target ignores this field.
CMD: This value is 0xFE (Report ID opcode)
ADDR: This value is 0x00000100. (ID register location)
LEN: This value is 0x02.
CRCH: CRC of fields CHAN, SOCK, CMD, ADDR, LEN; this field is 32 bits

### 5.8.1 ReportID Response Frame

FIG. 24 depicts a ReportID response frame format according to an embodiment.

Note: # denotes operational dependent values.
RESP: This value is 0xFE
CHAN: This value is the target's ChannelID found in the ID register.
SOCK: This value is the target's SocketID found in the ID register.
CRCR: CRC of fields RESP, CHAN, and SOCK. This field is 32 bits.
   5.8 ResetID Frame (CMD=0xFF)

Reset target's ChannelID and SocketID value on channel (c). This frame is usually used for target enumeration and isolation.

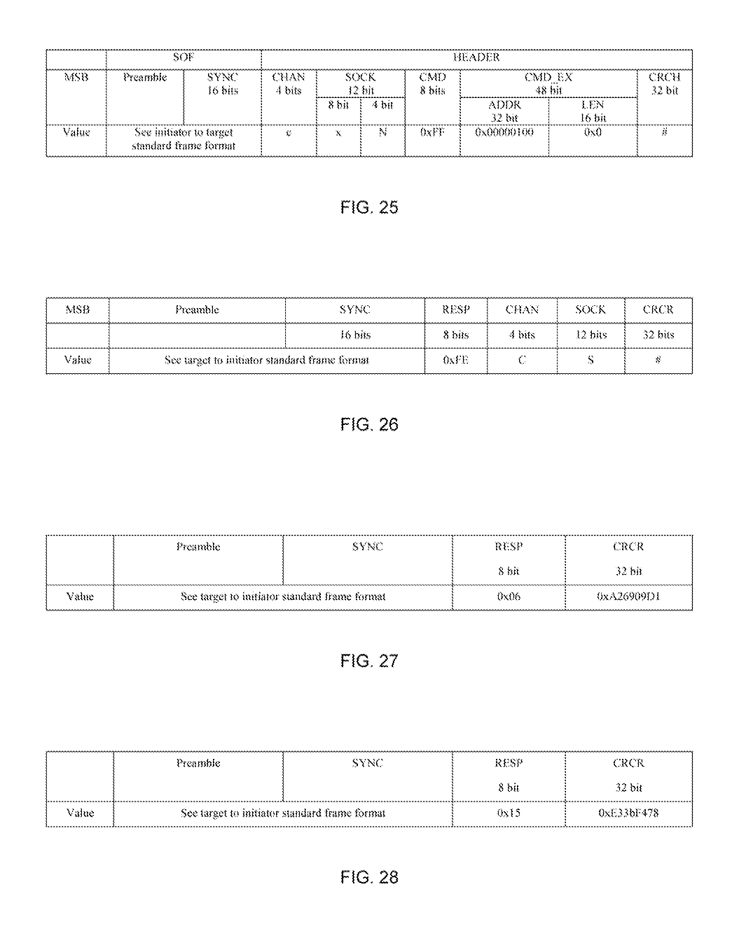

FIG. 25 depicts an initiator to target ‘ResetID’ frame according to an embodiment.

Note: x denotes any arbitrary values.

# denotes operational dependent values.

SOF field is described elsewhere.
CHAN: Channel number this frame is applied to. Valid values are 0 though 15. Channel 15 is the broadcast channel. All targets respond to a ‘ResetID’ frame if (c) matches its ChannelID or if (c) is 0xFF (broadcast channel).
SOCK: The initiator specifies the number of channels (N) available for this session. The value ranges from 1 through 13, all other values are invalid. The target ignores the 8 most significant bits
CMD: This value is 0xFFH (ResetID opcode)
ADDR: This value is 0x00000100H. (ID register location)
LEN: This value is 0x00H to indicate that no payload data is to follow.
CRCH: CRC of fields CHAN, SOCK, CMD, ADDR, LEN; this field shall be 32 bits

### 5.8.1 ResetID Response Frame

FIG. 26 depicts a ResetID response frame format according to an embodiment.

Note: # denotes operational dependent values.
RESP: This value is 0xFE (8 bits)
CHAN: This value is the target's ChannelID found in the ID register.
SOCK: This value is the target's SocketID found in the ID register.
CRCR: CRC of fields RESP, CHAN, and SOCK. This field is 32 bits.

### 5.9 Standard Response Frames

5.9.1 Acknowledgement—NAK (RESP=0x06)

FIG. 27 depicts an ‘ACK’ response frame format according to an embodiment.

5.9.2 Negative Acknowledgement—NAK (RESP=0x15)

FIG. 28 depicts a ‘NACK’ response frame format according to an embodiment.

### 6.0 Memory Map

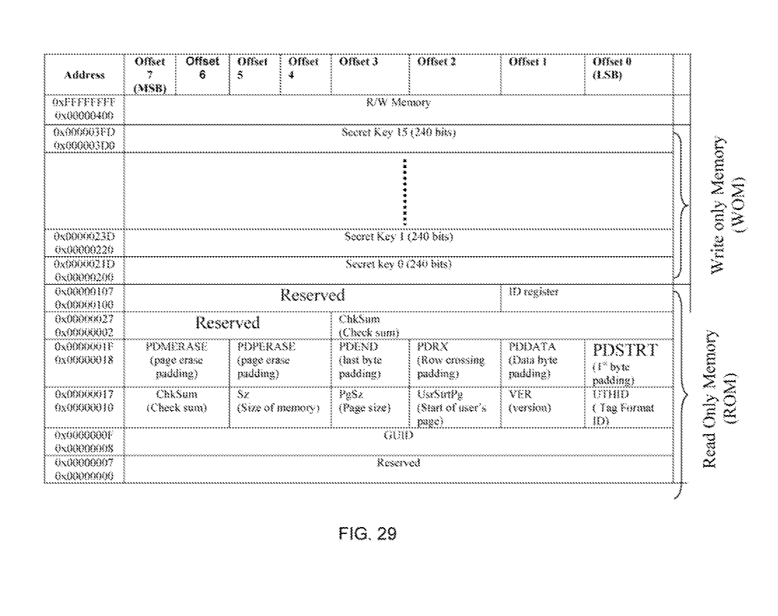

FIG. 29 depicts a memory map according to an embodiment. The target adopts the basic computer architecture memory model. The initiator controls the target by writing to various location of the target's memory. The initiator can obtain various operating parameters about the target by reading from the target's memory.

### 7.0 Error Checking

The CRCH, CRCP and CRCD fields are used to detect errors in the HEADER, OPERAND and PLD field respectively. The CRCR field is used to detect errors in the response frame. CRCH, CRCP, CRCD and CRCR is 32 bit. The 32 bit LFSR for the CRC is used in the initiator and target for generating and checking. It is constructed similarly using the CRC-802.3 generator polynomial:

g(d)=D26+D23+D22+D16+D12+D11+D0+D8+D7+D5+D4+D2+D1+1

The initial state of the LFSR is loaded with logical ‘1’. Data is shifted in and out as indicated. The resulting CRC value is attached to the respective field (i.e. CRCH, CRCP, CRCD, CRCR). The most significant byte is transmitted first. The most significant bit of each byte is transmitted first.

At the receiving side (initiator and target), the incoming CRC bits are clocked into the register. After the LSB bit is clocked, the 32 bit LFSR register contains all ‘1’s. The 32 bit CRC is calculated on all data bits up to, but not including, the first CRC bit.

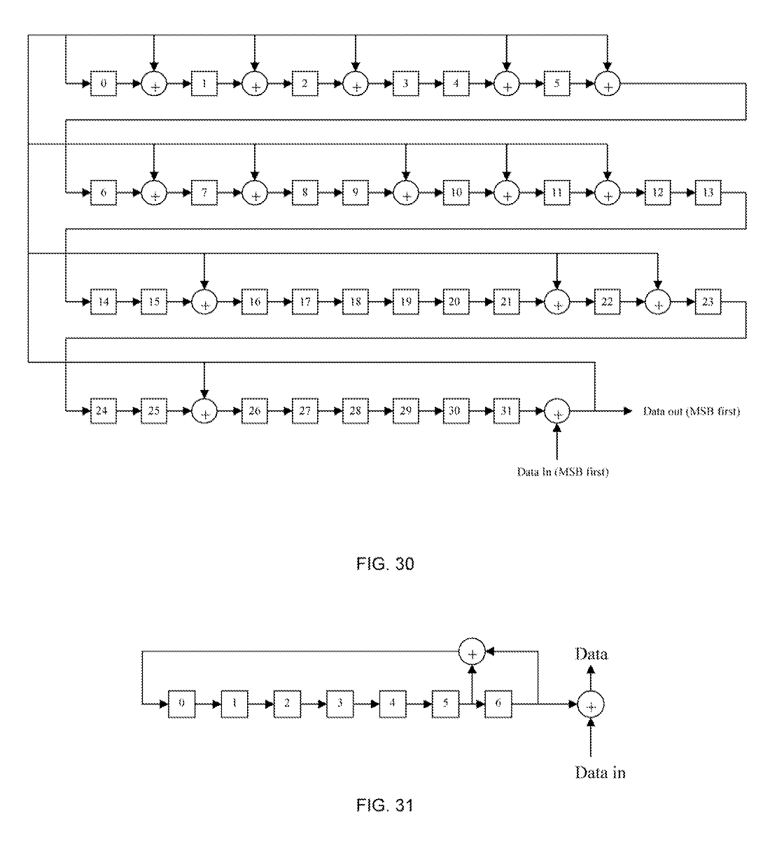

FIG. 30 depicts an LFSR circuit generating the CRC for initiator and target according to an embodiment.

8.0 Data Whitening

Target to initiator transmission are scrambled with a data whitening word in order to randomize the data from highly redundant patterns and to minimize DC bias in the packet. The scrambling is performed prior to the Frame synchronization.

At the initiator, the received data is descrambled using the same whitening word generated in the target. The descrambling is performed after Frame synchronization.

The whitening word is generated using a 7 bit LFSR with the polynomial f(D)=D7+D5+1 and subsequently exclusive ORed (EXORed) with the RESP, PLDR, and CRCR fields. Before each transmission, the shift register is initialized with logical ‘1’s. After initialization, the Response field (RESP), Payload field (PLDR) and CRC field (CRCR) are scrambled. The first bit of the “Data in” sequence is the MSB of the RESP field. An example embodiment is depicted in FIG. 31.

### Data Whitening LFSR for Initiator and Target

### 9.0 Authentication

The entity authentication used in Memory-tag uses a challenge-response scheme in which an initiator's knowledge of a secret key is checked through a 2-move protocol using symmetric secret keys. The latter implies that a correct initiator/target pair shared the same secret key.

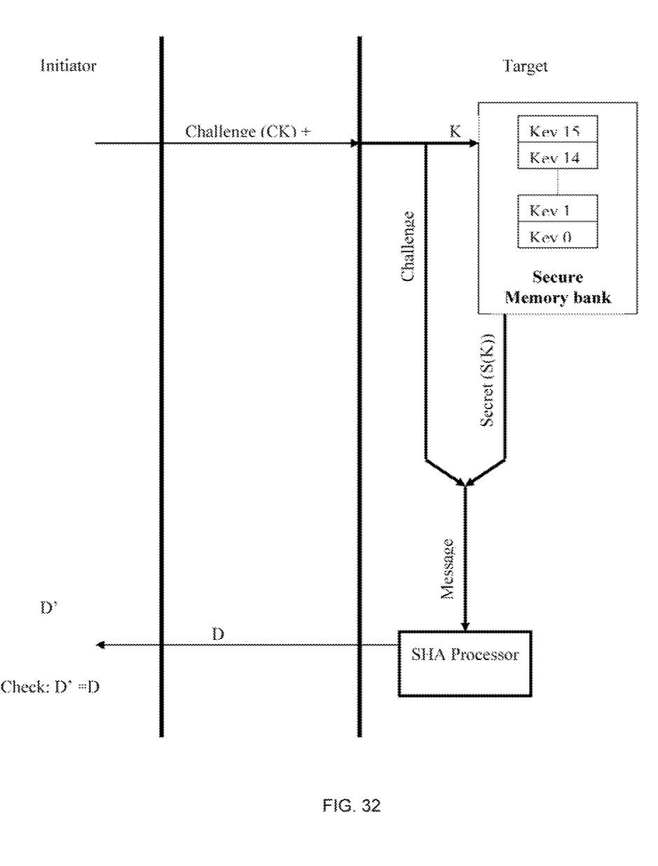

FIG. 32 depicts a Challenge-response for symmetric key systems according to an embodiment.

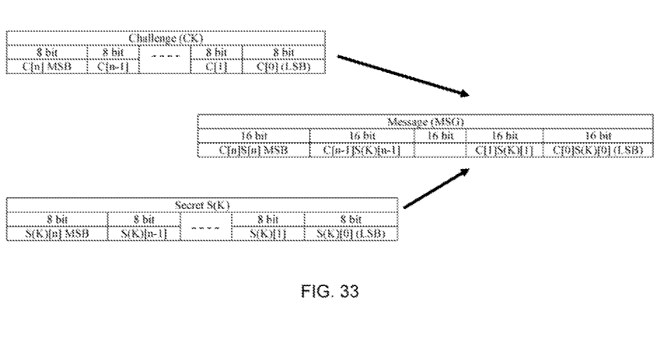

In the challenge-response scheme, the initiator challenges the target to authenticate a random input (the Challenge key), denoted by CK, with a 4 bit authentication key (K). K is a value between 0 and 15 and is used as a pointer to retrieve the secret key S(K) from the target's secure memory bank. A 480 bit string Message (MSG) consisting of the interleaving bytes Challenge (CK) and Secret S(k)) is formed, e.g., as depicted in FIG. 33.

The 480-bit string Message (MSG) is digested by the target's authenticator using a SHA-1 (FIPS PUB 180-1) compliant algorithm, producing a 160 bit Digest (D). SHA-1 algorithm is well documented and is freely available. The Digest (D) is sent back to the initiator. An alternate Digest (D′) may be calculated in the initiator using prior knowledge of the secret S(K) using the same technique. Alternatively, the alternate Digest (D′) may be calculated using another target. The targets with matching D=D′ implies that they share the same secret.

What is claimed is:

1. A method of enabling communication comprising:
transmitting a channel identifier and a socket identifier to an initiator responsive to performing a reset of the channel identifier and the socket identifier on one or more target devices;
communicating with an identified target device of the one or more target devices based on the transmitted channel identifier and the transmitted socket identifier of the identified target device responsive to receipt of the channel identifier and the socket identifier; and
enumerating two or more identified target devices of the one or more target devices based on a collision detection of transmitted channel identifiers and socket identifiers of the enumerated two or more identified target devices.

2. The method of claim 1, wherein the communicating is performed responsive to receipt of the transmitted channel identifier and the transmitted socket identifier having no cyclic redundancy check (CRC) errors.

3. The method of claim 1, wherein the enumerating is performed responsive to receipt of the transmitted channel identifier and the transmitted socket identifier having at least one CRC error.

4. The method of claim 1, wherein the enumerating comprises:
transmitting a response frame to the initiator responsive to receipt of a report identifier frame comprising a channel identifier corresponding to the channel identifier of the target device.

5. The method of claim 4, wherein the enumerating further comprises:
parking a target device responsive to receipt of a transmitted response frame having no CRC errors.

6. The method of claim 4, wherein the enumerating further comprises:
performing at least one of communicating with the target device or reassigning the target device to a new channel identifier responsive to receipt of a transmitted response frame having no CRC errors.

7. The method of claim 4, wherein the enumerating further comprises:
performing further enumeration of two or more target devices responsive to receipt of a transmitted response frame having at least one CRC error.

8. A memory or a computer-readable medium storing instructions which, when executed by a processor, cause the processor to
transmit a channel identifier and a socket identifier to an initiator responsive to performing a reset of the channel identifier and the socket identifier on one or more target devices;
communicate with an identified target device of the one or more target devices based on the transmitted channel identifier and the transmitted socket identifier of the identified target device responsive to receipt of the channel identifier and the socket identifier; and
enumerate two or more identified target devices of the one or more target devices based on a collision detection of transmitted channel identifiers and socket identifiers of the enumerated two or more identified target devices.
